(19) United States
(12) Patent Application Publication
(10) Pub. No.: US 2003/0144102 A1
(43) Pub. Date: Jul. 31, 2003

(54) Sprocket having a bearing protecting device

(76) Inventor: Chang Hui Lin, Chang Hua Hsien (TW)

Correspondence Address: CHARLES E. BAXLEY, 5th Floor, 59 John Street, New York, NY, 10038, US

(21) Appl. No.: 10/058,248

(22) Filed: Jan. 29, 2002

(51) Int. Cl. F16H 55/36; F16H 61/00; F16C 33/76

(52) U.S. Cl. 474/199; 474/80; 474/79; 384/478

(57) ABSTRACT

A sprocket includes a bore for receiving a bearing, and a pair of protecting casings engaged onto the sides of the sprocket for shielding and protecting the bearing, and for preventing dirty particles or the other particles from engaging into the bearing to damage the bearing, and for increasing the working life of the bearing and the sprocket. The bearing includes an inner sleeve having an orifice, the casings each includes a hub secured in the orifice of the inner sleeve. The casings each includes a peripheral fence having a chamber for receiving grease.

### BACKGROUND OF THE INVENTION

1. Field of the Invention

The present invention relates to a sprocket, and more particularly to a sprocket including a bearing protecting device for protecting the bearing.

2. Description of the Prior Art

Typical sprockets each includes a bearing engaged thereon. FIG. 1 shows the typical bearing 10 which includes an inner sleeve 11, an outer sleeve 12, one or more rollers or balls 13 engaged between the sleeves 11, 12, and two rings 14 engaged between the sleeves 11, 12 and engaged on the sides of the rollers or balls 13 for shielding and protecting the rollers or balls 13. The inner sleeve 11 includes an orifice 17 formed therein for receiving the spindles or the shafts or the like. However, dirt particles or the other contaminants may also enter into the bearing 10 and may have the bearing damaged quickly, particularly when the bearing 10 is engaged in the sprocket of the cycles and when the cycles are riding on dirty environment.

The present invention has arisen to mitigate and/or obviate the afore-described disadvantages of the conventional sprockets.

### SUMMARY OF THE INVENTION

The primary objective of the present invention is to provide a sprocket including a bearing protecting device for protecting the bearing and for preventing the bearing from being dirtied and damaged by the other particles, and for increasing the working life of the bearing.

In accordance with one aspect of the invention, there is provided a sprocket comprising a sprocket body including a bore formed therein, and including two sides, a bearing engaged in the bore of the sprocket body, and a pair of protecting casings engaged onto the sides of the sprocket body for shielding and protecting the bearing, and for preventing dirty particles or the other particles from engaging into the bearing to damage the bearing, and for increasing the working life of the bearing and the sprocket.

The bearing includes an inner sleeve having an orifice formed therein, the protecting casings each includes a hub engaged and secured in the orifice of the inner sleeve.

The protecting casings each includes a peripheral fence extended therefrom for covering and shielding the bearing.

The peripheral fence each includes a chamber formed therein for forming a space between the peripheral fence and the bearing and for receiving lubricating grease therein.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view illustrating the typical bearing for the sprockets or the like;

FIG. 2 is a perspective view of a sprocket in accordance with the present invention;

FIG. 3 is a partial exploded view of the sprocket; and

FIG. 4 is a cross sectional view taken along lines 4-4 of FIG. 2.

### DETAILED DESCRIPTION OF THE PREFERRED EMBODIMENT

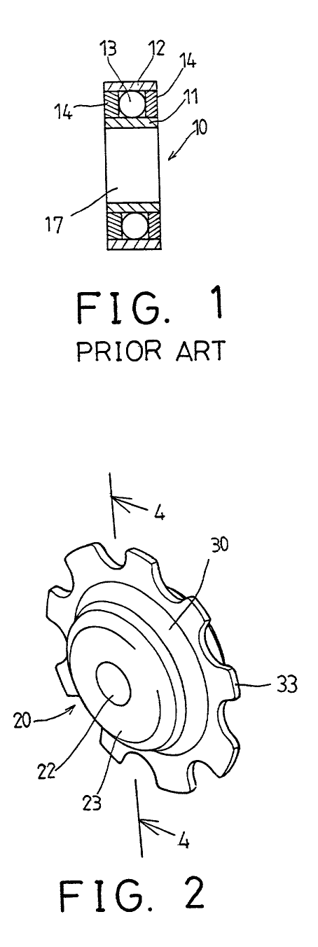

Referring to the drawings, and particularly to FIGS. 2-4, a sprocket in accordance with the present invention comprises a barrel or cylindrical or sprocket body 30 including an opening or a bore 31 formed therein, and including a number of teeth 33 extended radially outward from the outer peripheral portion thereof. A typical bearing 10 is engaged in the bore 31 of the cylindrical body 10, and also includes an inner sleeve 11, an outer sleeve 12, one or more rollers or balls 13 engaged between the sleeves 11, 12, and two rings 14 engaged between the sleeves 11, 12 and engaged on the sides of the rollers or balls 13 for shielding and protecting the rollers or balls 13. The outer sleeve 12 may be secured in the bore 31 of the cylindrical body 10 with such as a force-fitted engagement. The inner sleeve 11 also includes an orifice 17 formed therein for receiving the spindles or the shafts or the like.

The sprocket further includes a pair of bearing protecting casings 20 engaged onto the ends or the sides of the bearing 10 or the sides of the sprocket body 30, and each having a hub 21 engaged into the orifice 17 of the inner sleeve 11 of the bearing 10, and each having a peripheral fence 23 extended radially outward from the hub 21 for engaging with and for shielding or protecting the bearing 10. The peripheral fence 23 includes a depth or a thickness no less than or greater than that of the bearing 10, for completely or suitably covering and shielding and protecting the bearing 10, and for preventing the dirt particles or the like from entering into the bearing 10.

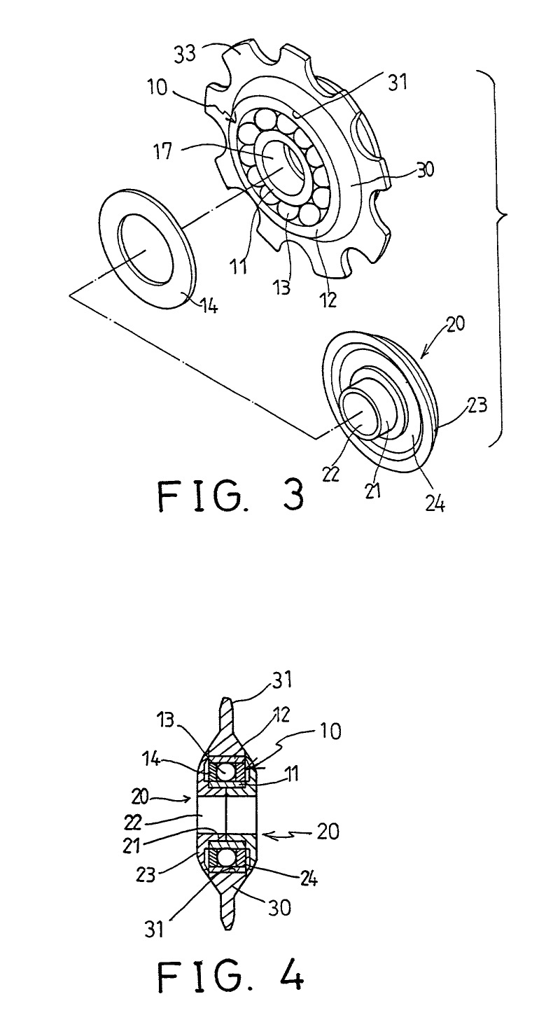

As best shown in FIGS. 3 and 4, the peripheral fences 23 of the bearing protecting casings 20 each preferably includes a recess or a peripheral chamber 24 formed therein for forming a space between the peripheral fence 23 and the bearing 10 and for receiving grease therein and for lubricating the bearing 10. The hubs 21 of the bearing protecting casings 20 each includes an aperture 22 formed therein for receiving the spindles or the shafts or the like of the cycles, for example.

In operation, as shown in FIG. 4, the bearing 10 may thus be suitably received and shielded and covered and protected by the protecting casings 20. In addition, grease or the like may be engaged into the space formed or provided between the protecting casings 20 and the bearing 10, for suitably lubricating the bearing 10. The bearing 10 may thus be suitably protected and the working life of the bearing 10 may thus be greatly increased.

Accordingly, the sprocket in accordance with the present invention includes a bearing protecting device for protecting the bearing and for preventing the bearing from being dirtied and damaged by the other particles, and for increasing the working life of the bearing.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprocket comprising:
a sprocket body including a bore formed therein, and including two sides,
a bearing engaged in said bore of said sprocket body, and
a pair of protecting casings engaged onto said sides of said sprocket body for shielding and protecting said bearing.

2. The sprocket according to claim 1, wherein said bearing includes an inner sleeve having an orifice formed therein, said protecting casings each includes a hub engaged and secured in said orifice of said inner sleeve.

3. The sprocket according to claim 1, wherein said protecting casings each includes a peripheral fence extended therefrom for covering and shielding said bearing.

4. The sprocket according to claim 3, wherein said peripheral fence each includes a chamber formed therein for forming a space between said peripheral fence and said bearing and for receiving lubricating grease therein.
